(19) United States
(12) Patent Application Publication
(10) Pub. No.: US 2009/0184234 A1
(43) Pub. Date: Jul. 23, 2009

(54) METHOD FOR ADJUSTING POSITION OF LASER EMITTING DEVICE

(75) Inventors: Takehiro Shindo, Yamanashi (JP); Tsutomu Hiroki, Yamanashi (JP)

Correspondence Address: PEARNE & GORDON LLP, 1801 EAST 9TH STREET, SUITE 1200, CLEVELAND, OH, 44114-3108, US

(73) Assignee: TOKYO ELECTRON LIMITED, Tokyo (JP)

(21) Appl. No.: 12/302,334

(22) PCT Filed: Aug. 27, 2007
(86) PCT No.: PCT/JP2007/066530

§ 371 Date: Nov. 25, 2008

(30) Foreign Application Priority Data
Oct. 10, 2006 (JP) 2006-276729

(51) Int. Cl. G01J 1/44

(52) U.S. Cl. 250/206

(57) ABSTRACT

Performed is a process of setting, on a mounting table, an adjustment substrate, which is provided with a slit of a preset width extended toward a center from a peripheral portion of the adjustment substrate; irradiating the laser beam toward a light receiving surface of a light energy measuring device, which is disposed on a front surface side of the adjustment substrate, from a rear surface side of the adjustment substrate through the slit; and measuring a variation in an energy amount of the laser beam irradiated onto the light receiving surface by the light energy measuring device while moving the laser emitting device in the optical axis direction, and adjusting a position of the laser emitting device in the optical axis direction to a desired position based on the variation in the energy amount on the light receiving surface.

### TECHNICAL FIELD

The present invention relates to a method for adjusting a position of a laser emitting device which irradiates a laser beam onto a target substrate mounted on a mounting table.

### BACKGROUND ART

In a series of processes for manufacturing a semiconductor device, a process using a laser beam may be performed on a target substrate, e.g., a semiconductor wafer (hereinafter, simply referred to as “wafer”) or a glass substrate for a liquid crystal display. The use of the laser beam is especially suitable for a process requiring high energy locally. For example, the following Patent Document 1 discloses a technique of forming a dicing line by scanning a laser beam along a substrate surface. Further, disclosed in the following Patent Document 2 is a technique of removing a resist film on an alignment mark, which is previously formed on a substrate, by a laser beam in order to expose the alignment mark prior to performing an exposure process on the substrate. Furthermore, the following Patent Document 3 discloses a technique of removing unnecessary materials deposited on an outer periphery of a wafer by a laser beam.

Further, as the semiconductor device becomes miniaturized, a higher accuracy is needed in adjusting a position of the laser beam used in the process. In addition, as a technology for adjusting the position of the laser beam, a filter is disposed between the laser beam and an optical power meter, and a position of the filter is accurately adjusted so as to place an optical axis of the laser beam to be coincident with a pinhole formed in the filter, and then a focal distance of the laser beam can be measured based on energy intensities obtained from the optical power meter while moving the filter along the optical axis (see, for example, Patent Document 4).
[Patent Document 1]: Japanese Patent Laid-open Publication No. 2002-224878
[Patent Document 2]: Japanese Patent Laid-open Publication No. 2003-249427
[Patent Document 3]: Japanese Patent Laid-open Publication No. 2006-049870
[Patent Document 4]: Japanese Utility Model Laid-open Publication No. H07-26711
[Patent Document 5]: Japanese Patent Laid-open Publication No. 2004-349425

### DISCLOSURE OF THE INVENTION

### Problems to Be Solved by the Invention

However, since the diameter of the laser beam varies depending on its position in an optical axis direction, the pinhole should be aligned with the optical axis of the laser beam when the focus of the laser beam is adjusted by using the pinhole. Therefore, according to the disclosure of Patent Document 4, it has been needed to make sure that the pinhole and the optical axis of the laser beam are exactly aligned with each other prior to performing the focus adjustment. However, since the pinhole has a minute diameter, this process has taken a considerable amount of time and labor.

In addition to the above-described optical power meter, a temperature of a laser beam absorber can be used for detecting an energy intensity of the laser beam (see, for example, Patent Document 5). According to the disclosure of Patent Document 5, when the laser beam emitted from an optical fiber is irradiated onto the laser beam absorber made up of a metal plate such as an iron plate or the like, a connection or disconnection of the optical fiber is detected based on a sudden change in the temperature of the laser beam absorber.

However, if the laser beam absorber is made up of the metal plate such as the iron plate, it can be easily influenced by the ambient temperature, so that it is difficult to accurately detect a change in the intensity of light energy. Accordingly, such laser beam absorber is not suitable for adjusting the focus of the laser beam requiring higher accuracy than detecting whether or not the optical fiber is connected.

The present invention has been conceived in view of the foregoing, and the object of the present invention is to provide a method for adjusting a position of a laser emitting device, capable of adjusting a focus or the like of the laser beam with a higher accuracy in a short period of time.

### Means for Solving the Problems

To solve the above-mentioned problems, in accordance with one aspect of the present invention, there is provided a method for adjusting a position of a laser emitting device which irradiates a laser beam onto a rear surface of a target substrate mounted on a mounting table, wherein the laser emitting device is configured to be movable in an optical axis direction of the laser beam emitted therefrom, the method including: setting, on the mounting table, an adjustment substrate, which is provided with a slit of a preset width extended toward a center from a peripheral portion of the adjustment substrate, so as to allow the laser beam emitted from the laser emitting device to pass through the slit; irradiating the laser beam toward a light receiving surface of a light energy measuring device, which is disposed on a front surface side of the adjustment substrate, from a rear surface side of the adjustment substrate through the slit; and measuring a variation in an energy amount of the laser beam irradiated onto the light receiving surface by the light energy measuring device while moving the laser emitting device in the optical axis direction, and adjusting the position of the laser emitting device in the optical axis direction to a desired position based on the variation in the energy amount on the light receiving surface.

In accordance with this method, a variation in the energy amount of the laser beam can be measured just by slightly moving the laser emitting device in the optical axis direction, so that it is possible to adjust the position of the laser emitting device in the optical axis direction to a desired position in a short period of time. Further, in the present invention, if the adjustment substrate is set on the mounting table in order for the laser beam emitted from the laser emitting device to pass through the slit, the slit is formed to extend from the peripheral portion toward the center, so that it is unnecessary to adjust the position of the laser beam in that direction. Therefore, the position of the laser beam can be easily adjusted. Accordingly, it is possible to reduce a time required for adjusting the position of the laser emitting device in the optical axis direction.

If the width of the slit is equal to or less than a diameter of a focus of the laser beam, it is desirable that the position of the laser emitting device in the optical axis direction is adjusted to a position at which the energy amount on the light receiving surface is maximum. In this manner, the focus of the laser beam can be easily adjusted to the rear surface of the adjustment substrate.

Further, if the width of the slit is larger than a diameter of a focus of the laser beam, it is desirable that the position of the laser emitting device in the optical axis direction is adjusted to a center position within a range in which the energy amount on the light receiving surface is in a saturated state. In this manner, it is also possible to easily adjust the focus of the laser beam to the rear surface of the adjustment substrate.

Furthermore, it is desirable that a spot diameter of the laser beam irradiated onto the rear surface of the target substrate is adjusted by adjusting the position of the laser emitting device in the optical axis direction such that a ratio with respect to a maximum value of the energy amount on the light receiving surface is reduced. With this method, a desired spot diameter can be obtained by properly setting the ratio.

When having a desired spot diameter, a ratio with respect to a maximum value of the energy amount on the light receiving surface may be calculated based on a ratio between a spot area of the laser beam at the rear surface of the adjustment substrate and the spot area's partial area exposed through the slit, and the position of the laser emitting device in the optical axis direction may be adjusted such that a ratio between the energy amount on the light receiving surface and the maximum value is equivalent to the calculated ratio. Since an area ratio can be calculated with a relatively simple calculation, the position of the laser emitting device in the optical axis direction can be adjusted in a short period of time.

To solve the above-mentioned problems, in accordance with another aspect of the present invention, there is provided a method for adjusting a position of a laser emitting device which irradiates a laser beam onto a rear surface of a target substrate mounted on a mounting table, wherein the laser emitting device is configured to be movable in an optical axis direction of the laser beam emitted therefrom, the method including: mounting, on the mounting table, an adjustment substrate provided with a plurality of slits, which are formed in a radial shape and have different widths from each other; selecting a slit having a width most equivalent close to a diameter of a focus of the laser beam among the plurality of slits, and adjusting a position of the adjustment substrate in order to allow the laser beam from the laser emitting device to pass through the selected slit; irradiating the laser beam toward a light receiving surface of a light energy measuring device, which is disposed on a front surface side of the adjustment substrate, from a rear surface side of the adjustment substrate through the slit; and measuring a variation in a energy amount of the laser beam irradiated onto the light receiving surface by the light energy measuring device while moving the laser emitting device in the optical axis direction of the laser beam, and adjusting the position of the laser emitting device in the optical axis direction to a desired position based on the variation in the energy amount on the light receiving surface.

In accordance with this method, even if the focus diameter of the laser beam is varied, it is possible to select the slit having a size closest to the focus diameter. Therefore, the position of the laser emitting device in the optical axis direction can be accurately and efficiently adjusted to a desired position.

To solve the above-mentioned problems, in accordance with still another aspect of the present invention, there is provided a method for adjusting a position of a laser emitting device which irradiates a laser beam onto a rear surface of a target substrate mounted on a mounting table, wherein the laser emitting device is configured to be movable in a direction orthogonal to an optical axis direction of the laser beam emitted therefrom, the method including; mounting, on the mounting table, an adjustment substrate having the same diameter as that of the target substrate; irradiating the laser beam from a rear surface side of the adjustment substrate toward a light receiving surface of a light energy measuring device disposed on a front surface side of the adjustment substrate; measuring a variation in an energy amount of the laser beam irradiated onto the light receiving surface by the light energy measuring device while moving the laser emitting device from an outer side of a peripheral portion of the adjustment substrate to an inner side thereof or vice versa in the direction orthogonal to the optical axis direction, and adjusting the position of the laser emitting device in the direction orthogonal to the optical axis direction based on the variation in the energy amount on the light receiving surface.

In accordance with this method, it is possible to measure the variation in the energy amount of the laser beam just by slightly moving the laser emitting device in the direction orthogonal to the optical axis direction, so that the position of the laser emitting device in the direction orthogonal to the optical axis direction can be adjusted in a short period of time.

In the process of adjusting the position of the laser emitting device, it is possible that the position of the laser emitting device in the direction orthogonal to the optical axis direction is adjusted to a desired position based on a position of the laser emitting device corresponding to a center between variation points among a variation in the energy amount on the light receiving surface obtained when the laser emitting device is moved between a portion at which a spot of the laser beam is completely not blocked by the adjustment substrate at the outer side of the peripheral portion of the adjustment substrate and a portion at which the spot of the laser emitting device is completely blocked by the adjustment substrate at the inner side of the peripheral portion of the adjustment substrate.

In accordance with this method, a reference position can be obtained with a simple calculation. Further, based on this reference position, it is possible to accurately adjust the position of the laser emitting device in the direction orthogonal to the optical axis direction.

Further, a spot diameter of the laser beam may be obtained from a position difference of the laser emitting device between the variation points of the energy amount on the light receiving surface. Accordingly, the spot diameter can be obtained without performing an additional process for measuring the spot diameter. Further, if the spot diameter has already been obtained, the spot diameter can be reconfirmed.

To solve the above-mentioned problems, in accordance with still another aspect of the present invention, there is provided a method for adjusting a position of a laser emitting device which irradiates a laser beam onto a rear surface of a target substrate mounted on a mounting table, wherein the laser emitting device is configured to be movable in an optical axis direction of the laser beam emitted therefrom and also in a direction orthogonal to the optical axis direction, the method including: a position adjusting process, in the optical axis direction, of mounting, on the mounting table, an adjustment substrate having the same diameter as that of the target substrate and including a slit with a preset width extended from a peripheral portion toward a center; adjusting the adjustment substrate in order for the laser beam emitted from the laser emitting device to pass through the slit; irradiating the laser beam to pass through the slit from a rear surface side of the adjustment substrate onto a light receiving surface of a light energy measuring device disposed on a front surface side of the adjustment substrate; measuring a variation in an energy amount of the laser beam irradiated onto the light receiving surface by the light energy measuring device while moving the laser emitting device in the optical axis direction; and adjusting a position of the laser emitting device in the optical axis direction to a desired position based on the variation in the energy amount on the light receiving surface; and a position adjusting process, in the direction orthogonal to the optical axis direction, of adjusting the position of the adjustment substrate on the mounting table to a position at which the laser beam does not pass through the slit; irradiating the laser beam from the rear surface side of the adjustment substrate onto the light receiving surface of the light energy measuring device disposed on the front surface side of the adjustment substrate; measuring a variation in an energy amount of the laser beam irradiated onto the light receiving surface by the light energy measuring device while moving the laser emitting device from an inner side toward an outer side of the peripheral portion of the adjustment substrate in the direction orthogonal to the optical axis direction; and adjusting the position of the laser emitting device in the direction orthogonal to the optical axis direction to a desired position based on the variation in the energy amount on the light receiving surface.

In accordance with this method, it is possible to adjust the position of the laser emitting device in the optical axis direction and in the direction orthogonal to the optical axis direction in a shorter period of time.

The light energy measuring device may include: a heating element for generating heat depending on the energy amount on the light receiving surface; a temperature measuring device for measuring a temperature of the heating element; and a vacuum container for maintaining the vicinity of the heating element in a vacuum atmosphere. Further, the light energy measuring device may include: a heating element made of ceramics which generates heat depending on the energy amount on the light receiving surface; and a temperature measuring device for measuring a temperature of the heating element. With this configuration, it is possible to accurately measure the variation in the energy amount on the light receiving surface regardless of the variation in the ambient temperature.

### Effect of the Invention

In accordance with the present invention, it is possible to more easily adjust the position of the laser beam because the slit formed in the adjustment substrate is used, and also it is possible to adjust the position of the laser emitting device capable of adjusting the focus of the laser beam with a higher accuracy in a short period of time.

### BRIEF DESCRIPTION OF THE DRAWINGS

FIG. 1 is a perspective view to explain a configuration example of a processing chamber to which a laser emitting device is applied in accordance with an embodiment of the present invention;

FIG. 2 is a side view of each unit in the processing chamber illustrated in FIG. 1;

FIG. 3 is a right side view of the processing chamber illustrated in FIG. 2;

FIG. 4 is a plane view of an adjustment wafer;

FIG. 5 is a perspective view showing a positional relationship between a laser head and a slit when the adjustment wafer is mounted on a mounting table;

FIG. 6A is a view showing a relationship between the slit and the laser beam when the adjustment wafer is mounted on the mounting table;

FIG. 6B illustrates a relationship between the slit and the laser beam when an end portion of the slit enters the laser beam;

FIG. 6C illustrates a relationship between the slit and the laser beam when the slit enters the laser beam completely;

FIG. 6D illustrates a relationship between the slit and the laser beam when the end portion of the slit starts to come out of the laser beam;

FIG. 6E illustrates a relationship between the slit and the laser beam when the slit is totally out of the laser beam;

FIG. 7 is a characteristic curve showing a relationship between a rotation angle of the adjustment wafer and an energy amount on a light receiving surface when the mounting table is rotated in a clockwise direction;

FIG. 8 illustrates a positional relationship between a slit of the adjustment wafer which is adjusted to have a rotation angle of θs and the laser beam;

FIG. 9 is a plane view of the adjustment wafer which is adjusted to have a rotation angle of θs;

FIG. 10A illustrates the laser beam passing through the slit when a focus is deviated from a rear surface of the adjustment wafer in the Z-direction;

FIG. 10B illustrates the laser beam passing through the slit when the focus is aligned to the rear surface of the adjustment wafer;

FIG. 10C illustrates the laser beam passing through the slit when the focus is deviated from the rear surface of the adjustment wafer in the minus Z-direction;

FIG. 11 is a characteristic curve showing a relationship between a position of a laser head in the Z-direction and an energy amount on a light receiving surface when the laser head is moved in the minus Z-direction;

FIG. 12 is a top plane view of the adjustment wafer when a spot diameter of the focus of the laser beam is identical with a width of the slit;

FIG. 13 is a top plane view of the adjustment wafer when a spot diameter of the focus of the laser beam is smaller than the width of the slit;

FIG. 14 is a characteristic curve showing a relation between a position of the laser head in the Z-direction and the energy amount on the light receiving surface when the laser head is moved in the minus Z-direction in case a spot diameter of the focus of the laser beam is smaller than the width of the slit;

FIG. 15 is a top plane view of the adjustment wafer when a spot diameter of the focus of the laser beam is larger than the width of the slit;

FIG. 16 is a characteristic curve showing a relation between a position of the laser head in the Z-direction and the energy amount on the light receiving surface when the laser head is moved in the minus Z-direction in case a spot diameter of the focus of the laser beam is larger than the width of the slit;

FIG. 17 is a plane view of an adjustment wafer having a plurality of slits;

FIG. 18 is a plane view showing a relation between a spot of the laser beam and a slit of the adjustment wafer when the adjustment of the spot diameter starts;

FIG. 19 is a plane view of the adjustment wafer showing a relationship between a laser beam having a spot diameter of Øs and the slit;

FIG. 20 is a characteristic curve showing a relationship between a position of the laser head in the Z-direction and the energy amount on the light receiving surface;

FIG. 21A illustrates the laser beam passing through the slit when a focus is aligned to the rear surface of the adjustment wafer;

FIG. 21B illustrates the laser beam passing through the slit when the laser head is adjusted to a position where a desired spot diameter can be obtained;

FIG. 22 is a side view showing a positional relation among each of units in a processing chamber right before starting the adjustment of a position of the optical axis;

FIG. 23 is a plane view of the adjustment wafer showing a trajectory of the spot of the laser beam in a rear surface level of the adjustment wafer when the laser head is moved toward the center of the adjustment wafer;

FIG. 24 is a characteristic curve showing a relationship between an R-directional position of the laser head and the energy amount on the light receiving surface when the laser head is moved toward the center of the adjustment wafer;

FIG. 25 is a plane view of the adjustment wafer when the center of the spot of the laser beam is aligned with the peripheral portion of the adjustment wafer;

FIG. 26 is a perspective view of an installation example of each of units in the processing chamber which has a ceramics block and a thermocouple as a light energy measuring device; and

FIG. 27 is a cross sectional view of a vacuum container containing a ceramics block.

### EXPLANATION OF CODES

100: laser emitting device
110: laser head
120: laser head base
130: Z-directional driving unit
140: R-directional driving unit
200: mounting table unit
210: mounting table
220: supporting shaft
300: laser power meter
302: detection area
310: ceramics block
312: thermocouple
314: supporting bar
316: wire
320: vacuum container
322: transmitting window
400: control unit
500˜504: slit
LB: laser beam
LBa: optical axis
W: wafer
Wadj, Wadj2: adjustment wafer

### BEST MODE FOR CARRYING OUT THE INVENTION

Hereinafter, desirable embodiments of the present invention will be described in detail with reference to the accompanying drawings. Through the whole documents, like reference numerals denote like parts having substantially identical functions and configurations, so that redundant description thereof may be omitted.

(Configuration Example of a Processing Chamber Including a Laser Emitting Device)

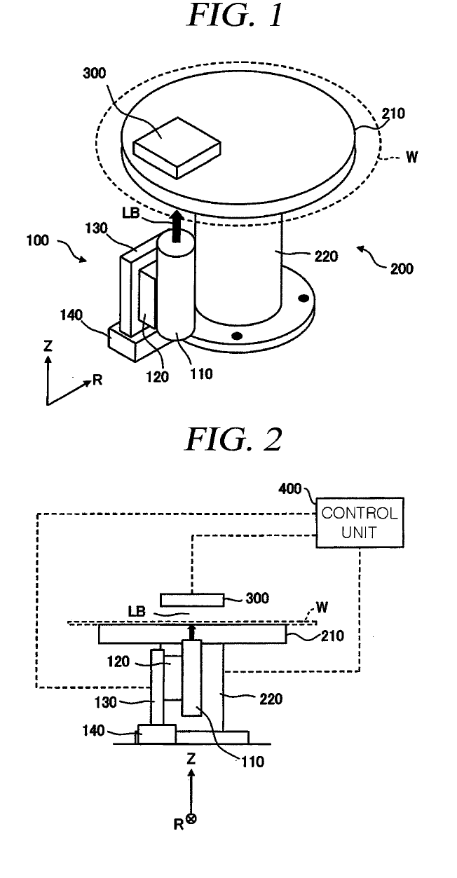

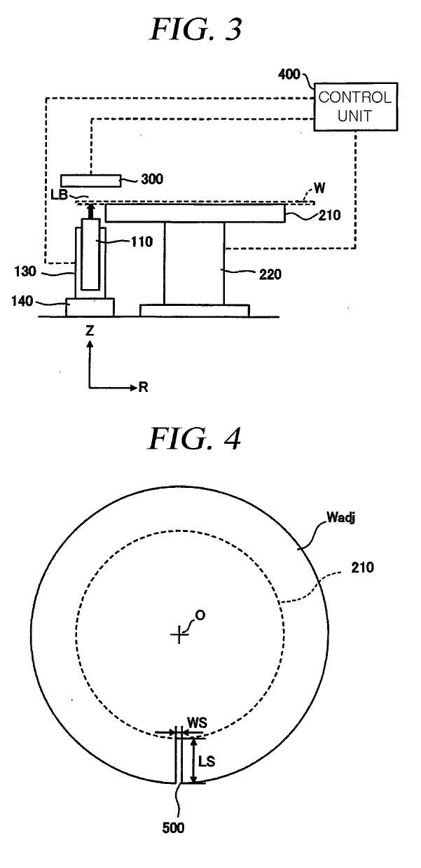

First of all, a processing chamber including a laser emitting device capable of performing a method of the present invention will be explained with reference to the accompanying drawings. Here, the explanation will be provided for, e.g., a processing chamber in which a cleaning process for removing an undesired material deposited on an end portion (e.g., a bevel portion) of a wafer is performed by irradiating a laser beam outputted from the laser emitting device onto a rear surface of the end portion of the wafer. FIG. 1 is a perspective view to explain an installation example of each unit including the laser emitting device in the processing chamber; FIG. 2 is a side view of each unit in the processing chamber illustrated in FIG. 1; and FIG. 3 is a right side view of FIG. 2.

The processing chamber includes therein, as illustrated in FIGS. 1 to 3, a mounting table unit 200 including a mounting table 210 on which a wafer W is mounted; a laser emitting device 100 for performing a predetermined process by irradiating a laser beam LB to a rear surface of the wafer W (e.g., a rear surface of a bevel portion) mounted on the mounting table 210; and a laser power meter 300 serving as a light energy measuring device for measuring a light energy amount by receiving the laser beam LB of the laser emitting device 100.

The mounting table 210, as illustrated in FIG. 1, is formed in, e.g., a circular plate shape having a smaller diameter than that of the wafer W. The wafer W is mounted on a mounting surface of a top side of the mounting table 210. The mounting table 210 is rotatably supported on a supporting shaft 220 which is installed on a lower surface of the processing chamber by means of a coupling member such as a bolt or the like. The supporting shaft 220 contains therein, e.g., a stepping motor by which the mounting table 210 can be rotated. Further, it is desirable that the mounting table 210 attracts and holds the wafer W mounted on the mounting surface thereof by, e.g., a vacuum chuck function or an electrostatic chuck function, whereby it is possible to prevent the wafer W from falling off the mounting table 210 even if the mounting table 210 is rotated at a high speed. The mounting table unit 200, as illustrated in FIGS. 2 and 3, is connected with a control unit 400 and the mounting table 210 can be rotated based on a control signal outputted from the control unit 400.

(Configuration Example of the Laser Emitting Device)

Hereinafter, a configuration example of the laser emitting device 100 will be explained in detail with reference to FIGS. 1 to 3. As illustrated in FIGS. 1 to 3, the laser emitting device 100 includes a laser head 110. The laser head 110 is a combination of, e.g., optical devices (not illustrated) such as a lens and a semiconductor laser device, and is capable of emitting a laser beam LB having a wavelength of, e.g., 808 nm in a Z-direction.

Further, the laser emitting device 100 includes a Z-directional driving unit 130 capable of being driven in a vertical direction (Z-direction) of the mounting surface of the mounting table 210; a R-directional driving unit 140 capable of being driven in a direction (R-direction) toward a rotational center from a periphery of the mounting table 210; and a laser head base 120 for connecting the laser head 110 to these two units. With this configuration, the laser emitting device 100 is capable of driving the laser head 110 in the Z-direction and the R-direction.

The Z-directional driving unit 130 is configured as, e.g., a stage capable of being linearly driven in the Z-direction, and the R-directional driving unit 140 is configured as, e.g., a stage capable of linearly driving the Z-directional driving unit 130 in the R-direction orthogonal to the Z-direction.

As an actuator for each of these driving units 130 and 140, it is desirable to use, e.g., a linear actuator. By using the linear actuator, it is possible to obtain a reproducibility of the positioning accuracy of several μm or less, and it is also possible to drive each stage at a high speed. In addition to the linear actuator, it may be possible to use, e.g., a combination mechanism of a ball screw and a stepping motor to drive each stage.

The laser emitting device 100, as illustrated in FIGS. 2 and 3, is connected with the control unit 400 and each of the driving units 130 and 140 is controlled based on a control signal outputted from the control unit 400. Further, it may be possible to control an emission timing or an output power of the laser beam LB emitted from the laser head 110 based on a control signal from the control unit 400.

A laser power meter 300 receives the laser beam LB emitted from the laser head 110 on a light receiving surface, and measures an energy amount of the received laser beam LB and then outputs a measurement result as a relative value. For example, it is possible to express a light energy amount on the light receiving surface (an energy amount on the light receiving surface) in a percentage. For example, when all the laser beams LB emitted from the laser head 110 reach the light receiving surface of the laser power meter 300, the energy amount on the light receiving surface becomes maximum, so that it is desirable to express this as 100%. Data indicative of the measurement result of the light energy amount measured by the laser power meter 300 are sent to the control unit 400.

Further, it may be possible to dispose the laser power meter 300 in the Z-direction of the laser head 110 only when it measures the light energy amount of the laser beam LB. During a period other than the measurement time, it is desirable to retreat it to a position where it does not overlap with the wafer W mounted on the mounting table 210 in the Z-direction.

With this arrangement, it is possible to easily mount the wafer W on the mounting table 210 without making any contact with the laser power meter 300. It is desirable to automatically perform the retreating operation of the laser power meter 300 in order to complete the operation in a short period of time while keeping the inside of the processing chamber clean.

The control unit 400, as stated above, controls the operations of the laser emitting device 100 and the mounting table unit 200 by transmitting the control signals thereto. Further, when it obtains the measurement result data of the light energy amount from the laser power meter 300, it stores the data in an internal storage unit (not illustrated). Further, the control unit 400 includes therein an operation unit (not illustrated) and is capable of performing various operations with the data stored in the storage unit by using this operation unit.

By using this laser emitting device 100, it is possible to adjust the position of the laser head 110 in the Z-direction by driving the Z-directional driving unit 130 and to accurately adjust a focus of the laser beam LB emitted from the laser head 110 to a rear surface of the wafer W. Besides, it is also possible to accurately adjust a spot diameter of the laser beam LB irradiated onto the rear surface of the wafer W by further adjusting the position of the laser head 110 in the Z-direction. Further, it is also possible to adjust the position of the laser head 110 in the R-direction by driving the R-directional driving unit 140 and to accurately align an optical axis of the laser beam LB emitted from the laser head 110 to a desired position of the rear surface of the wafer W. Hereinafter, an example of the method for adjusting the position of the laser emitting device 100 in accordance with the embodiment will be explained in detail.

(Method for Adjusting the Position of the Laser Emitting Device)

Hereinafter, an example of the method for adjusting the position of the laser emitting device 100 in accordance with the embodiment will be explained in detail. As for the method for adjusting the position of the laser emitting device 100 in accordance with the embodiment, as stated above, there are a method for adjusting the position of the laser emitting device 100 in an optical axis direction (Z-direction) and a method for adjusting the position of the laser emitting device 100 in a direction (R-direction) orthogonal to the optical axis direction. Further, as for the method for adjusting the position of the laser emitting device 100 in the optical axis direction (Z-direction), there are a method for adjusting the position so as to adjust the focal point of the laser beam LB to the rear surface of the wafer W and a method for adjusting the position so as to adjust the spot diameter of the laser beam LB irradiated onto the rear surface of the wafer W.

(Adjustment of the Focus of the Laser Beam According to the Method for Adjusting the Position of the Laser Emitting Device in the Optical Axis Direction)

First of all, the adjustment of the focus of the laser beam LB according to the method for adjusting the position of the laser emitting device 100 in the optical axis direction will be explained with reference to the accompanying drawings. When adjusting the focus of the laser beam LB, a wafer Wadj for the adjustment of the position of the laser emitting device (hereinafter, referred to as an “adjustment wafer”) as illustrated in FIG. 4 is mounted on the mounting table 210 instead of the product wafer W to be processed in the processing chamber in accordance with the present embodiment. There is formed a slit 500 on the adjustment wafer Wadj, as illustrated in FIG. 4. Further, it is desirable to set the adjustment wafer Wadj to have the same size as the wafer W.

When viewed from a plane direction of the adjustment wafer Wadj, the slit 500 is formed in a rectangular shape (having a width WS and a length LS) extending toward a center O from a peripheral portion. It is desirable to set the width WS of the slit 500 to be identical with a spot diameter (e.g., 0.6 mm) at a focus of the laser beam LB emitted from the laser head 110. Further, in the embodiment, even if the width WS of the slit 500 is not coincident with the spot diameter, it is still possible to perform the focus adjustment based on a size difference between the width of the slit and the spot diameter of the focus as stated below. Further, for example, the length LS of the slit 500 is set such that the slit 500 is formed on a portion projected from the mounting table 210 when the adjustment wafer Wadj is mounted on the mounting table 210.

The adjustment wafer Wadj having such shape is transferred into the processing chamber by, e.g., a wafer transfer unit (not illustrated), and is mounted on the mounting table 210 such that the center O of the adjustment wafer Wadj is aligned to a rotational center of the mounting table 210 in the same way as for the product wafer W. Then, the control unit 400 starts to perform the position adjustment process of the laser emitting device 100 to adjust the focus of the laser beam LB. Further, it may be possible for an operator to mount the adjustment wafer Wadj on the mounting table 210.

The position adjusting process of the laser emitting device 100 for adjusting the focus of the laser beam LB in accordance with the present embodiment includes: a process for adjusting the position of the laser head 110 in the R-direction; a process for adjusting the position of the slit 500 with respect to the laser beam LB; and a process for adjusting the position of the laser head 110 in the Z-direction. Hereinafter, each of these processes will be explained in detail.

First of all, the control unit 400 performs the process for adjusting the position of the laser head 110 in the R-direction. In this case, the position of the laser head 110 in the R-direction is adjusted so as to irradiate the laser beam LB onto the adjustment wafer Wadj's rear surface portion projected from the mounting table 210 (see FIG. 3).

When the position of the laser head 110 in the R-direction is adjusted, a high level of positional accuracy is not required. It may be sufficient if only the position of the laser head 110 in the R-direction is adjusted so as to irradiate the laser beam LB within a wide range of the length LS of the slit 500 of the adjustment wafer Wadj. The position of the laser head 110 in the R-direction is adjusted by controlling the R-directional driving unit 140 to align the optical axis of the laser beam LB to, for example, a position away from the peripheral portion of the adjustment wafer Wadj by ½ of the length LS of the slit 500 in an inward direction (R-direction) or its vicinity.

As stated above, in the present embodiment, it is not necessary to accurately adjust the position of the laser head 110 in the R-direction in order to use the adjustment wafer Wadj having the slit 500. Then, as will be stated below, it is possible to align the position of the slit 500 to the laser head 110 just by rotating the adjustment wafer Wadj, so that the position adjustment can be completed in a short period of time. Further, if a positional relation between the mounting table unit 200 and the laser emitting device 100 is maintained constant, it is not necessary to adjust the position of the laser head 110 in the R-direction every time. Therefore, it is possible to finish adjusting the position of the laser emitting device 100 in a shorter period of time.

On the contrary, if a pinhole is formed in the adjustment wafer Wadj instead of the slit 500, it is necessary to accurately adjust the position of the laser head 110 in the R-direction. Therefore, it will take more time to finish the position adjustment.

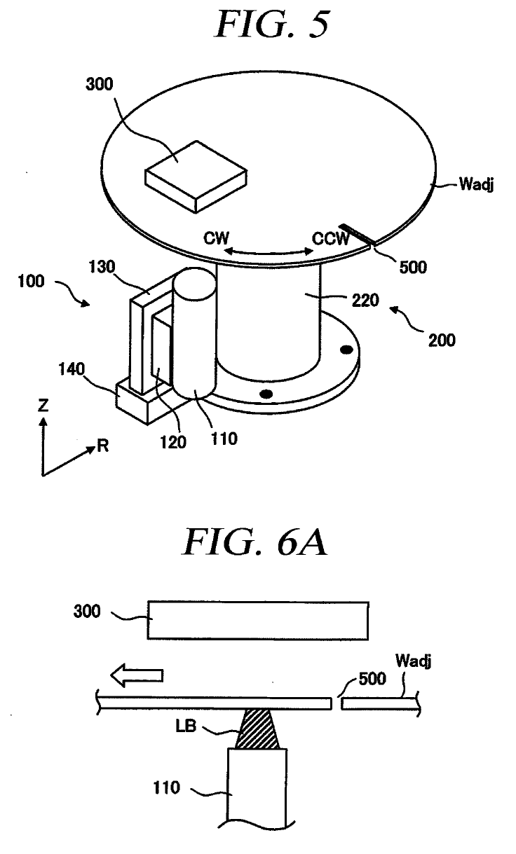

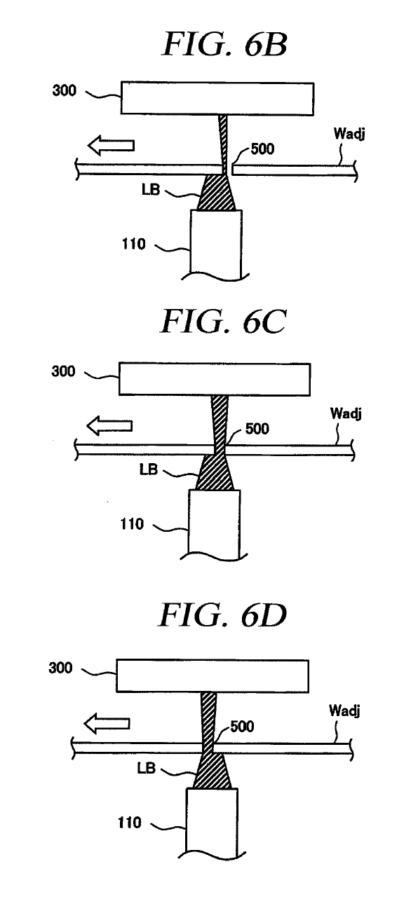

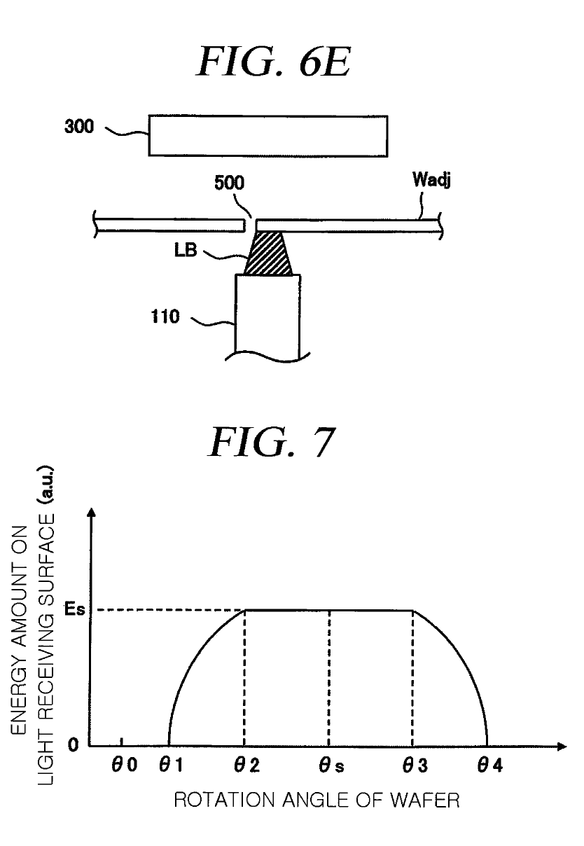

Subsequently, the control unit 400 adjusts the position of the slit 500 with respect to the laser beam LB. FIG. 5 is a perspective view showing a positional relation between the laser head 110 and the slit 500 when the adjustment wafer Wadj is mounted on the mounting table 210. As illustrated in FIG. 5, in the present embodiment, when the adjustment wafer Wadj is mounted on the mounting table 210, it is assumed that the optical axis of the laser beam LB emitted from the laser head 110 is deviated from the slit 500 in the rotational direction of the adjustment wafer Wadj. Accordingly, by rotating the mounting table 210, on which the adjustment wafer Wadj is mounted, in a clockwise direction CW or a counterclockwise direction CCW, the position of the slit 500 with respect to the optical axis of the laser beam LB emitted from the laser head 110 is adjusted. Hereinafter, the operation of adjusting the position of the slit 500 with respect to the laser beam LB will be explained with reference to FIGS. 6A to 6E and FIGS. 7 to 9.

FIGS. 6A to 6E provide enlarged cross sectional views of the adjustment wafer Wadj and its vicinity viewed in the R-direction from the laser head 110 and illustrate positional relations between the laser beam LB and the slit 500 in sequence when the mounting table 210 is rotated in the clockwise direction CW. Further, FIG. 7 illustrates a relationship between a rotation angle of the adjustment wafer Wadj and a light energy amount measured by the laser power meter 300 (i.e., a light energy amount of the laser beam LB arriving at the laser power meter 300) when the mounting table 210 is rotated in the clockwise direction CW.

In the present embodiment, as illustrated in FIG. 6A, when the adjustment wafer Wadj is mounted on the mounting table 210 having a rotation angle θ0, the position of the slit 500 is deviated from the laser beam LB emitted from the laser head 110. Therefore, all the laser beams LB are blocked by the adjustment wafer Wadj and can not reach the laser power meter 300, and as illustrated in FIG. 7, the light energy amount measured by the laser power meter 300 becomes “0.”

In this state, the control unit 400 transmits the control signal to the mounting table unit 200 and rotates the mounting table 210 in the clockwise direction CW. As a result of the rotation of the mounting table 210, the adjustment wafer Wadj is rotated up to a rotation angle θ1, and if an end portion of the slit 500 enters the laser beam LB as illustrated in FIG. 6B, the light energy amount measured by the laser power meter 300 starts to increase.

Then, if the mounting table 210 is further rotated and the slit 500 enters the laser beam LB completely as illustrated in FIG. 6C, the light energy amount measured by the laser power meter 300 reaches Es. At this time, a rotation angle of the adjustment wafer Wadj is θ2. Then, within a range from the rotation angle θ2 to a rotation angle θ3 at which the end portion of the slit 500 starts to come out of the laser beam LB (see FIG. 6D), the laser beam LB narrowed by the slit 500 to have the same light amount reaches the laser power meter 300, so that the light energy amount measured by the laser power meter 300 is maintained at Es as illustrated in FIG. 7.

Further, if the adjustment wafer Wadj is further rotated, the light amount of the laser beam LB passing through the slit 500 is reduced, and if the slit 500 is totally out of the laser beam LB as illustrated in FIG. 6E, the laser beam LB is all blocked by the adjustment wafer Wadj and can not reach the laser power meter 300. Therefore, as illustrated in FIG. 7, the light energy amount measured by the laser power meter 300 becomes “0” again.

As stated above, if the light energy amount is measured by the laser power meter 300 while rotating the adjustment wafer Wadj to have the rotation angle ranging from θ0 to θ4, the data indicative of the measurement result thereof are transmitted to the control unit 400 from the laser power meter 300. The control unit 400 can obtain a characteristic curve as illustrated in FIG. 7 based on the data obtained from the laser power meter 300 and the rotation angle information of the adjustment wafer Wadj (mounting table 210). In addition, the control unit 400 can calculate a rotation angle θs equivalent to a center value between the initial rotation angle θ2 and the final rotation angle θ3 in the range in which the light energy amount is maintained constant at Es. The rotation angle θs can be acquired by calculating, e.g., a mean value of the rotation angle θ2 and the rotation angle θ3.

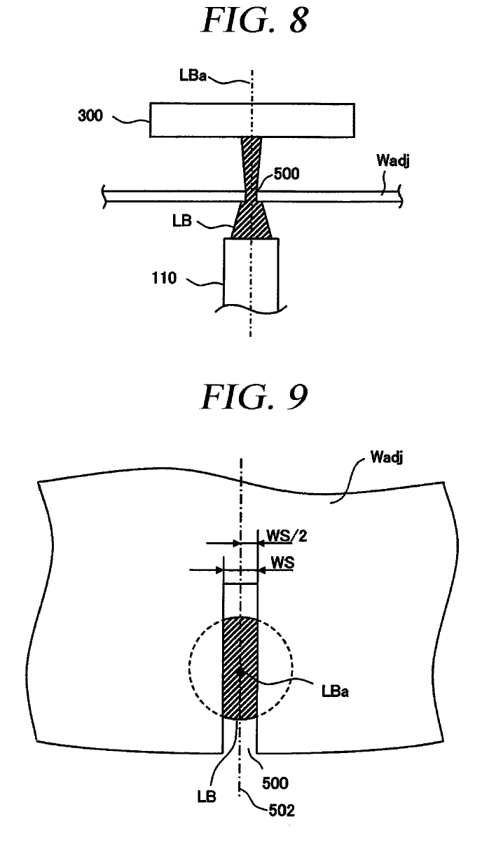

The control unit 400 adjusts the rotation angle of the adjustment wafer Wadj to become θs by transmitting the control signal to the mounting table unit 200 to rotate the mounting table 210 in the counterclockwise direction CCW. FIG. 8 provides a side view of the cross section of the adjustment wafer Wadj rotated at the rotation angle of θs and its vicinity when viewed from the laser head 110 in the R-direction, and FIG. 9 is a top plane view of the adjustment wafer Wadj adjusted at the rotation angle of θs. As illustrated in FIGS. 8 and 9, by adjusting the rotation angle of the adjustment wafer Wadj to be θs, it is possible to accurately align the optical axis LBa of the laser beam LB to a center line 502 of the slit 500 in a width direction thereof.

In order to obtain the rotation angle of θs in the above-stated manner, it is sufficient if only the control unit 400 can specify the rotation angles θ2 and θ3. A difference between these two rotation angles corresponds to the spot diameter of the laser beam LB on the rear surface of the adjustment wafer Wadj. Since the spot diameter is very small, the difference between the rotation angles is also small. Further, in order to specify the rotation angles of θ2 and θ3, it is not necessary to rotate the adjustment wafer Wadj from the rotation angle θ0 to the rotation angle θ4 as stated above. For example, it is sufficient if only the adjustment wafer Wadj is rotated from a rotation angle right before the rotation angle θ2 to a rotation angle right after the rotation angle θ3. Therefore, the rotation angles θ2 and θ3 can be specified just by rotating the adjustment wafer Wadj slightly. As stated above, in accordance with the present embodiment, it is possible to complete the position adjustment of the slit 500 with respect to the laser beam LB in the short period of time.

Further, it may be possible to set the adjustment wafer Wadj on the mounting table 210 while performing the position adjustment such that the slit 500 is aligned to the optical axis of the laser beam LB. In this case, since it is not necessary to adjust the position of the slit 500 with respect to the laser beam LB, the position adjustment of the laser emitting device 100 can be completed in a shorter period of time.

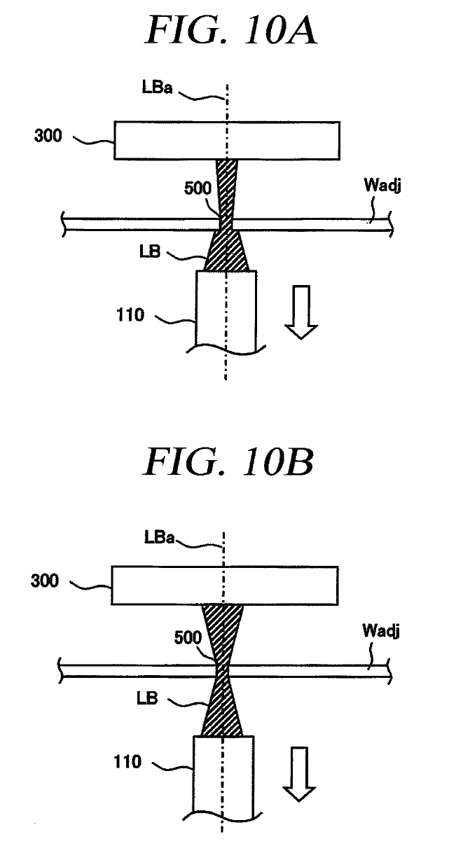

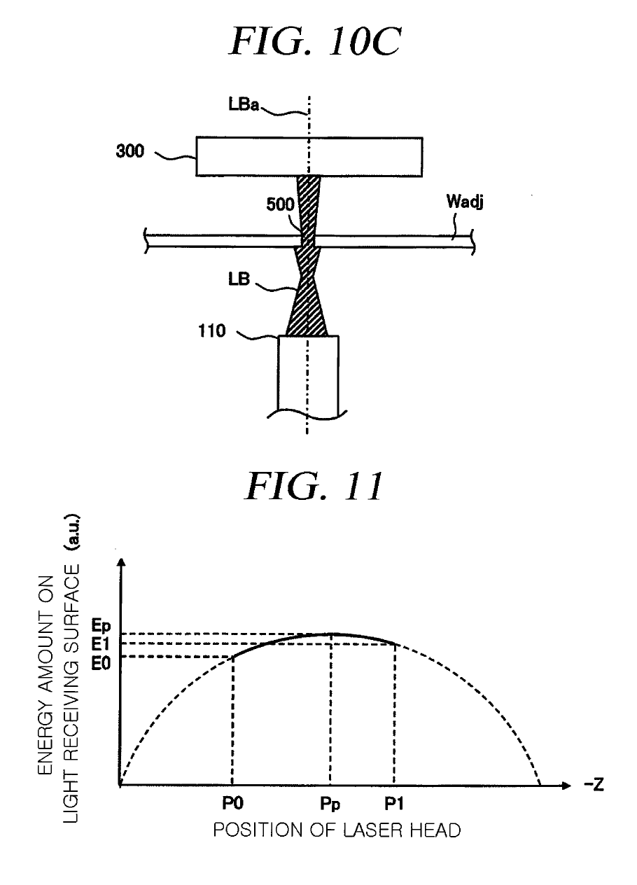

The control unit 400 adjusts the position of the laser head 110 in the Z-direction and adjusts the focus of the laser beam LB on the rear surface of the adjustment wafer Wadj after finishing the position adjustment of the slit 500 with respect to the laser beam LB. Hereinafter, the position adjustment process of the laser head 110 in the Z-direction will be described with reference to FIGS. 10A to 10C and FIG. 11.

FIGS. 10A to 10C provide enlarged cross sectional views of the adjustment wafer Wadj and its vicinity viewed from the laser head 110 in the R-direction and illustrate the laser beam LB passing through the slit 500 when the laser head 110 is moved in a minus Z-direction (downward). Further, FIG. 11 illustrates a relationship between the position of the laser head 110 in the Z-direction (Z-coordinate) and a light energy amount measured by the laser power meter 300 when the laser head 110 is moved in the minus Z-direction (downward).

At the time the position adjustment of the laser head 110 in the Z-direction is started, the optical axis of the laser beam LB is aligned exactly to the center line 502 of the slit 500 in the width direction, as illustrated in FIG. 9. Therefore, a part of the laser beam LB emitted from the laser head 110 reaches the laser power meter 300. As illustrated in FIG. 10A, however, the focus of the laser beam LB is deviated from the rear surface of the adjustment wafer Wadj in the Z-direction (upward) so that the other part of the laser beam LB is blocked by the adjustment wafer Wadj and does not reach the laser power meter 300. Accordingly, a light energy amount measured by the laser power meter 300 is less than a light energy amount Ep measured when the entire laser beam LB reaches the light receiving surface. At this time, a position of the laser head 110 in the Z-direction is referred to as P0, and a light energy amount measured by the laser power meter 300 is referred to as E0.

In this state, the control unit 400 moves the laser head 110 in the minus Z-direction by transmitting the control signal to the laser emitting device 100 and driving the Z-directional driving unit 130. If the laser head 110 moves in the minus Z-direction, the spot diameter of the laser beam LB irradiated onto the rear surface of the wafer W is gradually decreased, so that a ratio of the laser beam LB passing through the slit 500 increases, resulting in an increase of the light energy amount measured by the laser power meter 300 as shown in FIG. 11.

Then, the laser head 110 is further moved in the minus Z-direction and, as illustrated in FIG. 10B, on a point where the focus of the laser beam LB is aligned on the rear surface of the adjustment wafer Wadj, the light energy amount measured by the laser power meter 300 reaches Ep. The Z-directional position of the laser head 110 at that moment is referred to as Pp.

As stated above, in the present embodiment, since the width WS of the slit 500 is approximately the same as the spot diameter of the focus of the laser beam LB, the entire laser beam LB emitted from the laser head 110 reaches the laser power meter 300 at the time the focus of the laser beam LB is aligned on the rear surface of the adjustment wafer Wadj. Therefore, Ep represents a peak value of the light energy amount measured by the laser power meter 300. However, at the time the laser head 110 is moved to a position Pp, it is not clear whether or not the light energy amount Ep represents the peak value. In order to make it clear, the control unit 400 further moves the laser head 110 to a position P1 in the minus Z-direction by transmitting the control signal to the laser emitting device 100 and driving the Z-directional driving unit 130.

Accordingly, as illustrated in FIG. 10C, the focus of the laser beam LB is deviated from the rear surface of the adjustment wafer Wadj in the minus Z-direction, so that a part of the laser beams LB is blocked by the adjustment wafer Wadj and can not reach the laser power meter 300. As a result, the light energy amount measured by the laser power meter 300 becomes E1 which is smaller than Ep.

As stated above, if the light energy amount is measured by the laser power meter 300 while moving the laser head 110 from the position P0 to the position P1, the data indicative of the measurement result thereof is transmitted to the control unit 400 from the laser power meter 300. The control unit 400 can obtain a characteristic curve as illustrated in FIG. 11 based on the data obtained from the laser power meter 300 and the Z-direction position information of the laser head 110 (Z-directional driving unit 130). Further, the control unit 400 specifies the peak value Ep of the light energy amount and the position Pp of the laser head 110 at that time from the characteristic curve of FIG. 11.

The control unit 400 adjusts the laser head 110 to be located at the position Pp by transmitting the control signal to the laser emitting device 100 and driving the Z-directional driving unit 130 in the Z-direction (see FIG. 10B). By performing the position adjustment of the laser head 110 in the Z-direction in this manner, it is possible to accurately adjust the focus of the laser beam LB on the rear surface of the adjustment wafer Wadj.

As stated above, in the position adjustment of the laser head 110 in the Z-direction, it is necessary to move the laser head 110 from the position P0 to the position P1 (or from the position P1 to the position P0) in order to specify the peak value Ep of the light energy amount and the position Pp of the laser head 110 at that time. In this case, it is sufficient that a distance between the position Pp and the position P0 and a distance between the position Pp and the position P1 is short. That is, it is possible to specify the position P0 just by moving the laser head 110 a short distance. As stated, in accordance with the present embodiment, it is possible to accurately align the focus of the laser beam LB on the rear surface of the adjustment wafer Wadj in a very short period of time.

(Other Examples of the Focus Adjustment)

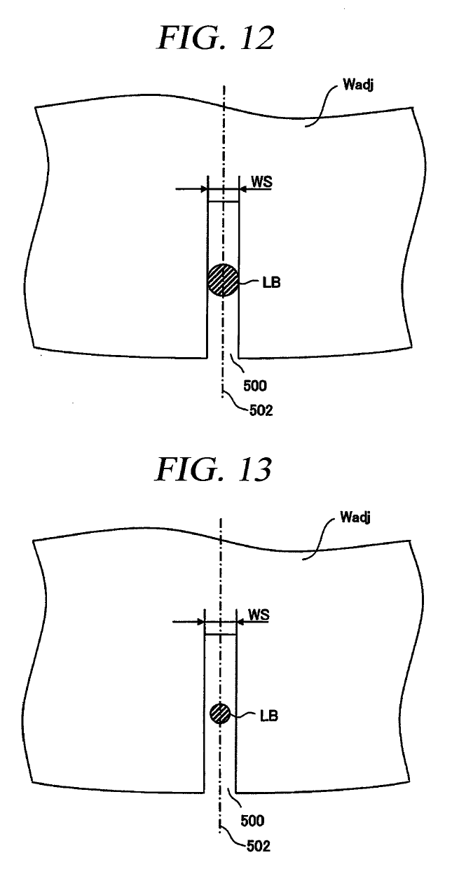

Hereinafter, other examples of the focus adjustment of the laser beam will be explained with reference to the accompanying drawings. Though the above-stated example of the focus adjustment has been explained for the case where the spot diameter of the focus of the laser beam LB is the same as the width WS of the slit 500, the focus can be adjusted likewise even if the spot diameter of the focus of the laser beam LB is different from the width WS of the slit 500. Such a case will be explained below with reference to FIGS. 12 to 16.

FIG. 12 is a top plane view of the adjustment wafer Wadj when the spot diameter of the focus of the laser beam LB is the same as the width WS of the slit 500; FIG. 13 is a top plane view of the adjustment wafer Wadj when the spot diameter of the focus of the laser beam LB is smaller than the width WS of the slit 500; and FIG. 15 is a top plane view of the adjustment wafer Wadj when the spot diameter of the focus of the laser beam LB is larger than the width WS of the slit 500.

In case the spot diameter of the focus of the laser beam LB is the same as the width WS of the slit 500 (see FIG. 12), if the laser head 110 is moved in the Z-direction, as stated above, the characteristic curve as illustrated in FIG. 11 can be obtained. Further, the control unit 400 can accurately align the focus of the laser beam LB on the rear surface of the adjustment wafer Wadj by specifying the peak value Ep of the light energy amount and the position Pp of the laser head 110 at that moment from the characteristic curve of FIG. 11.

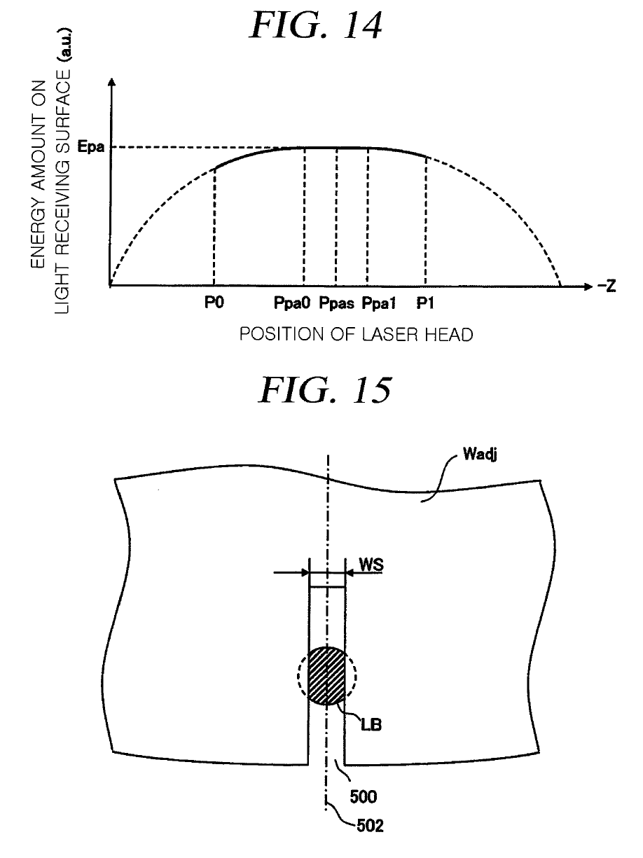

Meanwhile, if the laser head 110 is moved in the Z-direction in case that the spot diameter of the focus of the laser beam LB is smaller than the width WS of the slit 500 (see FIG. 13), a characteristic curve as illustrated in FIG. 14 can be obtained. The feature of the characteristic curve of FIG. 14 resides in that there is a range (from a position Ppa0 to a position Ppa1) in which the light energy amount becomes saturated at a point of Epa because the entire laser beam LB reaches the laser power meter 300 without being blocked by the adjustment wafer Wadj even in case the focus of the laser beam LB is slightly deviated from the rear surface of the adjustment wafer Wadj in the Z-direction and the minus Z-direction.

In this manner, in case the spot diameter of the focus of the laser beam LB is smaller than the width WS of the slit 500, the control unit 400 calculates a center position Ppas between the position Ppa0 and the position Ppa1, and by adjusting the laser head 110 to that point Ppas, it is possible to accurately align the focus of the laser beam LB on the rear surface of the adjustment wafer Wadj. Further, the position Ppas can be obtained by calculating, e.g., a mean value of the position Ppa0 and the position Ppa1.

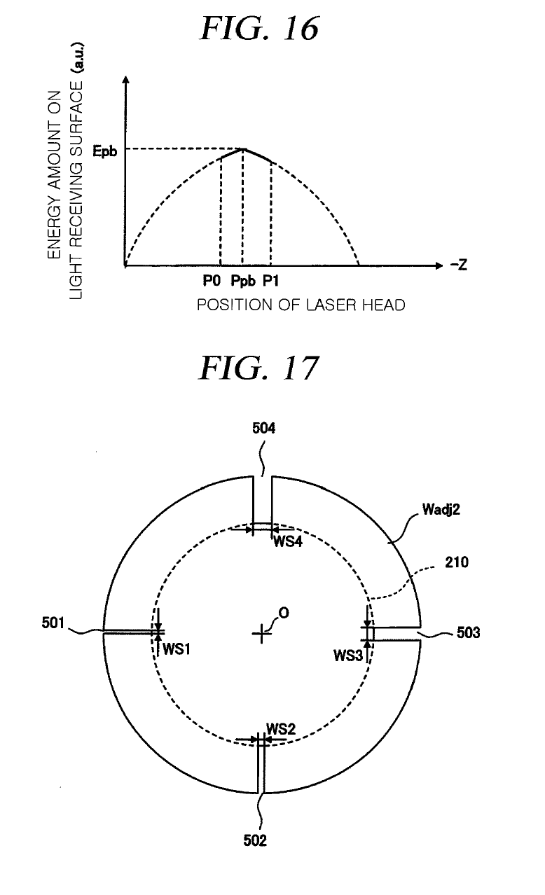

Further, if the laser head 110 is moved in the Z-direction in case that the spot diameter of the focus of the laser beam LB is larger than the width WS of the slit 500 (see FIG. 15), a characteristic curve as illustrated in FIG. 16 can be obtained. The control unit 400 specifies a peak value Epb of the light energy amount and a position Ppb of the laser head 110 at that moment from the characteristic curve of FIG. 16. Further, the control unit 400 can accurately align the focus of the laser beam LB on the rear surface of the adjustment wafer Wadj by adjusting the laser head 110 to such a position Ppb.

As stated above, in the present embodiment, it is possible to accurately align the focus of the laser beam LB on the rear surface of the adjustment wafer Wadj even if the spot diameter of the focus of the laser beam LB is different from the width WS of the slit 500. However, as illustrated in FIG. 12, if the spot diameter of the focus of the laser beam LB is the same as the width WS of the slit 500, the position Pp can be directly obtained, but if the spot diameter of the focus of the laser beam LB is smaller than the width WS of the slit 500 as illustrated in FIG. 13, it is necessary to calculate, e.g., the average between the position Ppa0 and the position Ppa1 so as to obtain the position Ppas. In order to accurately align the focus of the laser beam LB on the rear surface of the adjustment wafer Wadj in a shorter period of time, it is desirable that the spot diameter of the focus of the laser beam LB is the same as the width Ws of the slit 500. In this case, it may be possible to use an adjustment wafer Wadj2 illustrated in FIG. 17 instead of the adjustment wafer Wadj used in the above-stated embodiment.

The adjustment wafer Wadj2 is provided with plural slits 501 to 504 arranged in a radial shape toward a center from a peripheral portion, and the respective slits 501 to 504 have different widths WS1 to WS4. Further, if the focus adjustment is performed by selecting one of the slits 501 to 504 depending on the spot diameter of the focus of the laser beam LB, the focus adjustment can be completed in a shorter period of time.

(Adjustment of the Spot Diameter of the Laser Beam According to the Method for Adjusting the Position of the Laser Emitting Device in the Optical Axis Direction)

Hereinafter, an adjustment of the spot diameter of the laser beam according to the position adjustment method of the laser emitting device will be explained. Depending on a wafer process, there may be an occasion where the spot diameter of the laser beam irradiated onto the rear surface of the wafer needs to be changed to a different size other than the diameter of the focus. As stated above, in case the undesired material deposited on the rear surface of an end portion of the wafer (e.g., a bevel portion) is removed by using, e.g., the laser beam LB, it is possible to efficiently remove the material deposited in a wide area by enlarging the spot diameter of the laser beam LB irradiated onto the rear surface of the wafer W. Besides, though a light energy per a unit area decreases as the spot diameter of the laser beam is increased, it is possible to adjust a temperature of the wafer by lengthening the period of time of irradiation of the laser beam as much.

Besides, it may be possible to change the spot diameter of the laser beam depending on the kind of an etching target film on the wafer or depending on an etching rate. For example, in case the etching rate is changed depending on the kind of the film on the wafer, it may be possible to adjust the spot diameter of the laser beam LB irradiated onto the rear surface of the wafer W according to a desired etching rate.

Further, in the same manner as in the case of the focus adjustment process of the laser beam LB, if it is possible to complete the adjustment of the spot diameter of the laser beam LB irradiated onto the rear surface of the wafer W in a time period as short as possible, a throughput of the process using the laser emitting device 100 can be enhanced.

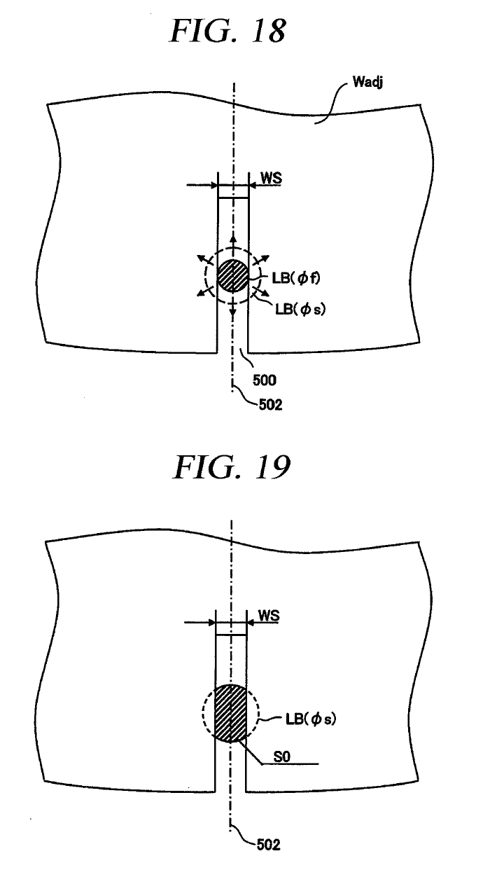

Hereinafter, the adjustment of the spot diameter of the laser beam LB in accordance with the method for the position adjustment of the laser emitting device 100 will be explained with reference to the accompanying drawings. It is desirable to perform the process for adjusting the spot diameter of the laser beam LB in accordance with the present embodiment immediately after the focus adjustment process of the laser beam LB. If the process is performed at this timing, the focus of the laser beam LB has been adjusted to the rear surface of the adjustment wafer Wadj by the time of starting the process for adjusting the spot diameter. Further, since the focus diameter of the laser beam LB is the same as the width WS of the slit 500, the entire laser beam LB can pass through the slit 500. FIG. 18 is a top plane view of the adjustment wafer Wadj when the control unit 400 starts the process for adjusting the spot diameter. Further, an input value inputted in advance by a manipulation of an input unit (not illustrated) by an operator is used as a desired spot diameter Øs when performing the spot diameter adjusting process of the laser beam LB.

The control unit 400 obtains a ratio (S0/S) of an area S0 exposed through the slit 500 to a spot area S in case that the spot diameter of the laser beam LB irradiated onto the rear surface of the adjustment wafer Wadj is Øs. FIG. 19 is a top plane view of the adjustment wafer Wadj when the laser beam LB is irradiated onto the rear surface of the adjustment wafer Wadj and the spot diameter at that time is Øs.

It is possible to obtain the area S from the spot diameter Øs and the area S0 from the width WS of the slit 500 and the spot diameter Øs. Further, the area ratio S0/S can be easily obtained. If a luminous flux density is uniform throughout the entire region of the spot, the area ratio is the same as a ratio of light amount (hereinafter, referred to as “light amount ratio”) of the laser beam LB passing through the slit 500 to the entire light amount of the laser beam LB emitted from the laser emitting device 110. Further, this light amount ratio corresponds to a ratio of the light energy amount measured by the laser power meter 300. Further, if there is any specific distribution in the luminous flux density of the spot, it may be possible to obtain the light amount ratio by correcting the area ratio depending on such a distribution.

Accordingly, by obtaining the area ratio S0/S in case of the desired spot diameter Øs, the control unit 400 can specify the light energy amount with respect to the peak value Ep of the light energy amount, i.e., a value of the light energy amount when the entire laser beam LB reaches the laser power meter 300 after passing through the slit 500.

The control unit 400 already obtained the characteristic curve (see FIG. 11) showing the relationship between the position of the laser head 110 in the Z-direction and the light energy amount measured by the laser power meter 300 when the focus adjustment of the laser beam LB was performed, and this characteristic curve is used herein as well.

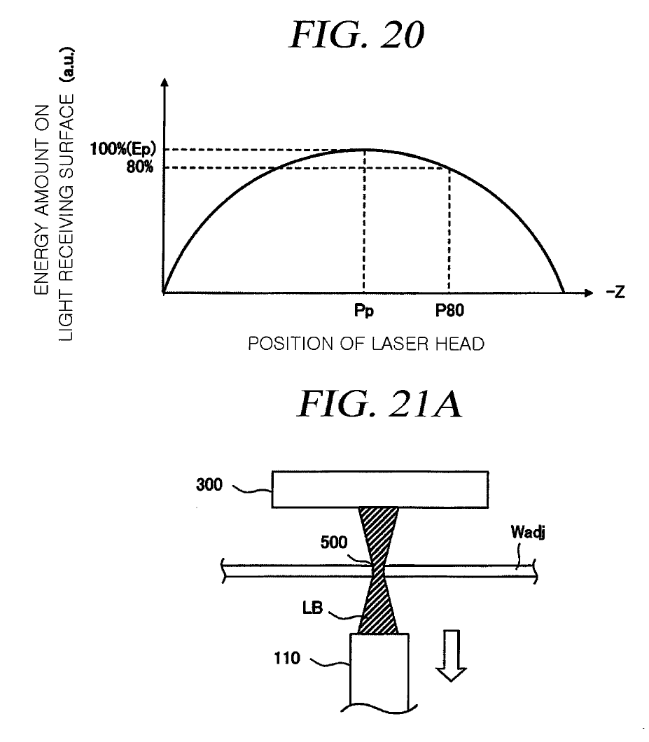

For example, when the area ratio S0/S is calculated to be 80%, the control unit 400 obtains the light energy amount corresponding to 80% when the peak value Ep of the light energy amount is set to be 100% based on the characteristic curve as illustrated in FIG. 20, and also specifies a position P80 of the laser head 110 in the Z-direction at which 80% of the light energy amount can be obtained.

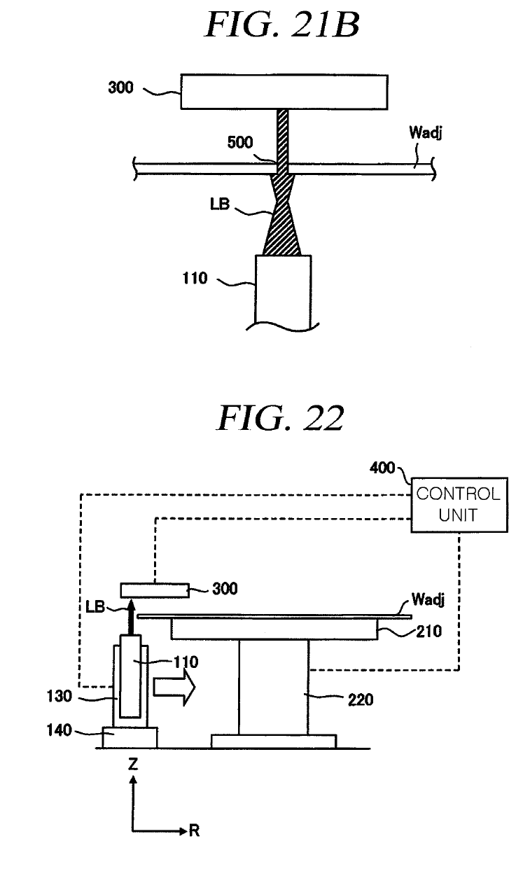

Subsequently, the control unit 400 transmits the control signal to the laser emitting device 100 and drives the Z-directional driving unit 130 so as to move the laser head 110 from the position Pp (see FIG. 21A) to the position P80 (see FIG. 21B) in the minus Z-direction. FIGS. 21A and 21B provide enlarged cross sectional views of the adjustment wafer Wadj and its vicinity viewed from the laser head 110 in the R-direction and illustrate the shape of the laser beam LB passing through the slit 500 when the laser head 110 is moved in the minus Z-direction. In this case, the spot of the laser beam LB is enlarged from the diameter Øf of the focus to the desired diameter Øs as illustrated in FIG. 18.

As stated above, according to the position adjustment method of the laser emitting device 100 for adjusting the spot diameter of the laser beam LB in accordance with the present embodiment, if the area ratio is obtained from the desired spot diameter Øs and the width WS of the slit 500, it becomes easy to specify the position of the laser head 110 in the Z-direction at which such spot diameter Øs can be obtained. Therefore, it is possible to adjust the spot diameter of the laser beam LB irradiated onto the rear surface of the wafer W in a short period of time, whereby the throughput of the process using the laser emitting device 100 can be enhanced.

(Method for Adjusting the Position of the Laser Emitting Device in the Direction Orthogonal to the Optical Axis Direction)

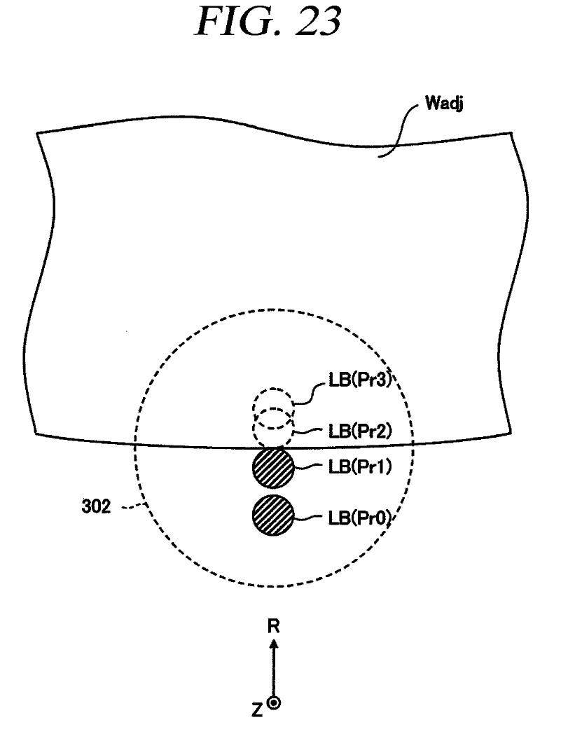

Hereinafter, the method for adjusting the position of the laser emitting device in the direction orthogonal to the optical axis direction will be explained with reference to the accompanying drawings. In this case, the explanation will be provided for an example process for adjusting the position of the optical axis of the laser beam LB irradiated onto the rear surface of the wafer W. FIG. 22 is a side view showing a positional relation among each of units in the processing chamber right before starting the position adjustment of the optical axis. As illustrated in FIG. 22, in the present embodiment, the laser head 110 is set at a position outside the peripheral portion of the adjustment wafer Wadj, and the adjustment wafer Wadj is rotated such that a position of the slit 500 does not face the laser head 110. It may be possible to use a different adjustment wafer having no slit installed therein instead of using the adjustment wafer Wadj having the slit.

Then, the control unit 400 transmits the control signal to the laser emitting device 100 and drives the R-directional driving unit 140 so as to move the laser head 110 toward the center of the adjustment wafer Wadj, i.e., in the R-direction. The laser power meter 300 measures the light energy amount at this time and transmits the data indicative of the measurement result to the control unit 400.

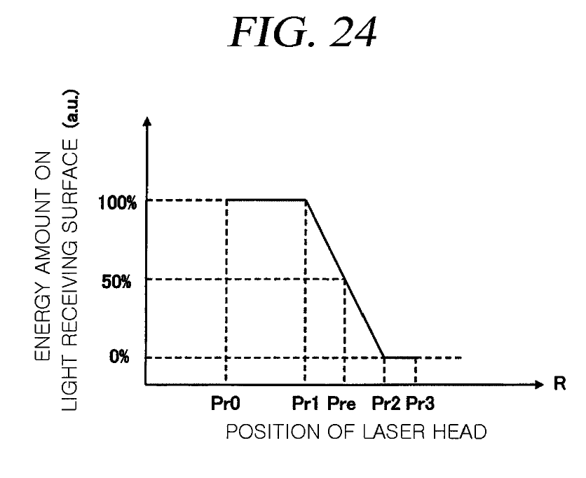

FIG. 23 is a top plane view of the adjustment wafer Wadj and illustrates a trajectory of the spot of the laser beam LB at the rear surface level of the adjustment wafer Wadj when the laser head 110 is moved toward the center of the adjustment wafer Wadj. Further, FIG. 24 illustrates a relation between the R-directional position of the laser head 110 and a light energy amount measured by the laser power meter 300 when the laser head 110 is moved toward the center of the adjustment wafer Wadj likewise. Further, as illustrated in FIG. 23, a light energy amount detection area 302 of the laser power meter 300 is set to cover the full movement range of the spot of the laser beam LB. For example, the diameter of the detection area 302 is about 25 mm.

First of all, the control unit 400 moves the laser head 110, outside the peripheral portion of the adjustment wafer Wadj, from a position Pr0 at which the entire spot of the laser beam LB is not blocked by the adjustment wafer Wadj, to a position Pr1 at which the spot of the laser beam LB reaches the peripheral portion of the adjustment wafer Wadj. Between the position Pr0 and the position Pr1, the light energy amount measured by the laser power meter 300 is maintained at a maximum value (100%) because the entire laser beam LB reaches the laser power meter 300 in this range.

Then, the laser head 110 is moved, inside of the peripheral portion of the adjustment wafer Wadj, to a position Pr2 at which the spot of the laser beam LB is completely blocked by the adjustment wafer Wadj. Between the position Pr1 and the position Pr2, the laser beam LB is gradually blocked by the adjustment wafer Wadj, so that the amount of the laser beam LB reaching the laser power meter 300 becomes decreased. Therefore, the light energy amount measured by the laser power meter 300 decreases from the maximum value. Further, at the position Pr2, the entire laser beam LB is blocked by the adjustment wafer Wadj, so that the light energy amount measured by the laser power meter 300 becomes a minimum value (0%).

Subsequently, the laser head 110 is moved to a position Pr3. Between the position Pr2 and the position Pr3, the laser beam LB is completely blocked by the adjustment wafer Wadj, so that the light energy amount measured by the laser power meter 300 is maintained at the minimum value (0%).

In this manner, if the light energy amount is measured by the laser power meter 300 while moving the laser head 110 from the position Pr0 to the position Pr3, the data indicative of the measurement result are transmitted from the laser power meter 300 to the control unit 400. The control unit 400 can obtain a characteristic curve, as illustrated in FIG. 24, showing a variation of the light energy amount based on the data obtained from the laser power meter 300 and the information on the R-directional position of the laser head 110 obtained from the laser emitting device 100.

Further, the control unit 400 calculates a position Pre corresponding to a center position between a variation point (position Pr1) at which the light energy amount starts to decrease and a variation point (position Pr2) at which the decrease stops. The position Pre can be obtained by calculating, e.g., a mean value of the R-directional coordinates of the position Pr1 and the position Pr3. In addition, it is also possible to calculate a mean value of the maximum and minimum values of the light energy amount, and obtain a position corresponding to the mean value from the characteristic curve in FIG. 24, and set this position as the position Pre.

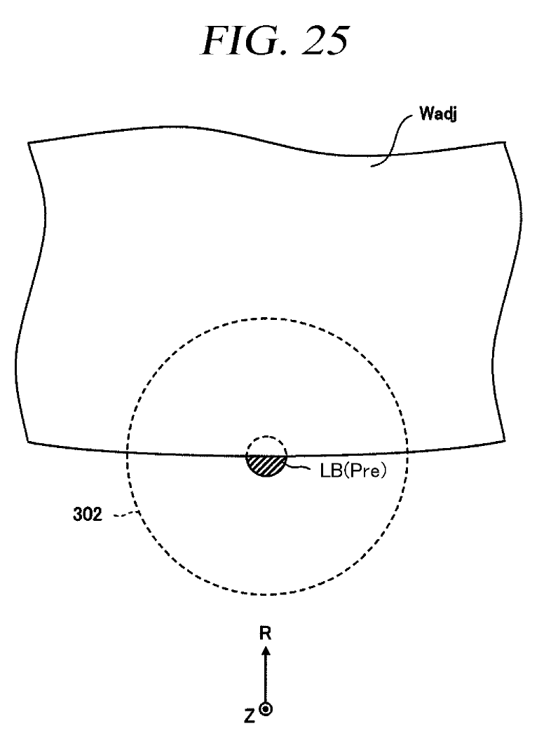

By moving the laser head 110 to the position Pre, the center of the spot of the laser beam LB (i.e., the optical axis of the laser beam LB) emitted from the laser head 110 is aligned with the peripheral portion of the adjustment wafer Wadj, as illustrated in FIG. 25. Further, if the position Pre can be obtained, the control unit 400 then can move the laser head 110 to a predetermined position in the R-direction based on it.

As stated above, according to the position adjusting method of the laser emitting device 100 for adjusting the position of the optical axis of the laser beam LB in accordance with the present embodiment, it is possible to specify the position Pre, which is a reference position of the laser head 110 in the R-direction, just by moving the laser head 110 from the position Pr0 to the position Pr3 while measuring the light energy amount by the laser power meter 300. Besides, since a distance between the position Pr0 and the position Pr3 is very short, the control unit 400 can specify the position Pre immediately. Accordingly, the position of the laser head 110 in the R-direction can be adjusted in a short period of time.

However, the moving direction of the laser head 110 for specifying the position Pre is not limited to the R-direction. For example, if the focus adjustment or the spot diameter adjustment has been carried out before performing the position adjustment of the laser head 110 in the R-direction, the laser head 110 may be located at a position where the optical axis is blocked by the adjustment wafer Wadj, i.e., the same position as the position Pr3. Therefore, it may be possible to specify the position Pre by moving the laser head 110 in the minus R-direction. In this case, since it is not necessary to move the laser head 110 to the position Pr1 before starting the process, the position Pre can be specified in a shorter period of time.

Further, if the spot diameter is unknown, it is necessary to move the laser head 110 from the position Pr0 to the position Pr3 as stated above. In contrast, when the focus adjustment or the spot diameter adjustment has been carried out, for example, the spot diameter is recognized by the control unit 400. Therefore, if the position Pr1 can be specified, it is possible to set a position distanced away from the position Pr1 by a half of the spot diameter as the position Pre. In this case, since it is sufficient if only the laser head 110 is moved from the position Pr0 to a position exceeding the position Pr1, it is possible to specify the position Pre in a shorter period of time.

Besides, since a difference between the position Pr1 and the position Pr2 is the same as the spot diameter, the spot diameter can be calculated by moving the laser head 110 from the position Pr0 to the position Pr3 even in case that the spot diameter is unknown. Meanwhile, when the spot diameter is already known, it is possible to confirm the already-known spot diameter based on the difference between the position Pr1 and the position Pr2.

(Other Configuration Examples of the Light Energy Measuring Device)

Hereinafter, there will be explained other configuration examples of the light energy measuring device with reference to the accompanying drawings. The above description has been provided for the case of applying the laser power meter 300 as an example of the light energy measuring device, in which the use of the laser power meter 300 enables an accurate measurement of the light energy amount of the laser beam LB at a high speed without having to divide a large space.

However, there is a likelihood that laser power meters may have a wide range of variations between their products. Therefore, for example, if different laser power meters are used for the position adjustment of laser emitting devices installed in plural processing chambers, there is a likelihood that the positions of the laser emitting devices in respective processing chambers may not be uniform. Further, the measurement result from the laser power meter may fluctuate if a small amount of contaminant is deposited on the light receiving surface thereof. Accordingly, in case of using the laser power meter, it becomes difficult to obtain a stable measurement result over a long period of time.

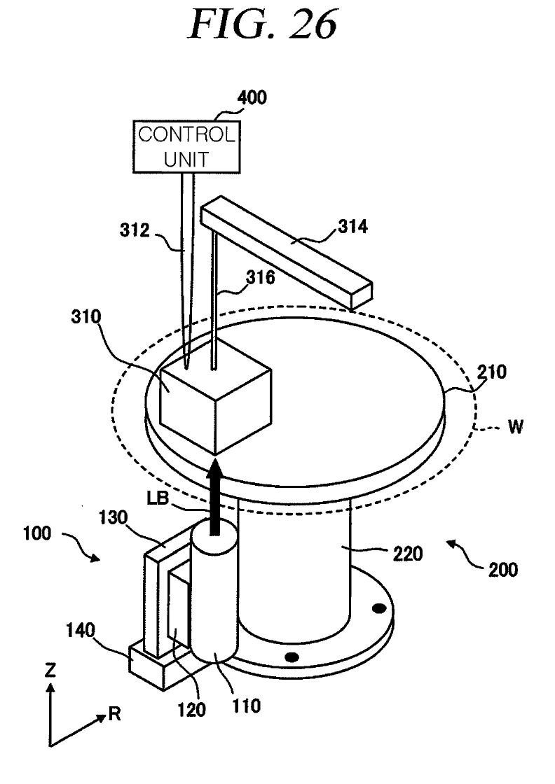

Therefore, as another example of the light energy measuring device, it may be possible to use a measuring device made up of a ceramics block 310 as a heating element and a thermocouple 312 as a temperature measuring device, as illustrated in FIG. 26. The ceramics block 310 generates heat depending on a received light energy amount when the laser beam LB emitted from the laser head 110 is irradiated thereon. One end of the thermocouple 312 is connected to the ceramics block 310 and the other end is connected to the control unit 400. Further, the ceramics block 310 is suspended on the optical axis of the laser beam LB by a wire 316 hung from a supporting bar 314 of which a basal end is fixed to, e.g., a side wall (not illustrated) of the processing chamber. It is desirable that the wire 316 is made of a material from which heat is not taken away by the ceramics block 310.

This measuring device can measure the amount of the light energy reaching the ceramics block 310 among the laser beam LB emitted from the laser head 110. To be specific, when the laser beam LB is irradiated onto the ceramics block 310 in a certain period of time, the temperature of the ceramics block 310 increases depending on the amount of the received light energy. This temperature increment is converted into an electrical signal by the thermocouple 312 and then transmitted to the control unit 400.

The control unit 400 specifies the temperature increment of the ceramics block 310 based on the electrical signal from the thermocouple 312. Further, the control unit 400 can calculate the light energy amount of the laser beam LB by multiplying a heat capacity of the ceramics block 310, which is known in advance, by the temperature increment of the ceramics block 310. Besides, the light energy amount of the laser beam LB obtained here is an absolute value.

In this manner, since the light energy measuring device can be implemented by such a simple structure, it is possible to prevent the non-uniformity of measurement of each measuring device. Further, the cost for the measuring device can be reduced. Besides, since the measurement results can be obtained as the absolute values, it is easy to compare the measurement results.

In addition, since the heating element is made of the ceramics having a high specific heat, it is hardly influenced by a change in the temperature of its vicinity, in comparison with a heating element made of metal such as iron having a low specific heat. Therefore, the light energy amount can be measured more accurately.

Further, even if some contaminants are deposited on the surface of the ceramics block 310, it does not exert a great influence on the temperature rising characteristics of the ceramics block 310 due to the irradiation of the laser beam LB thereon.

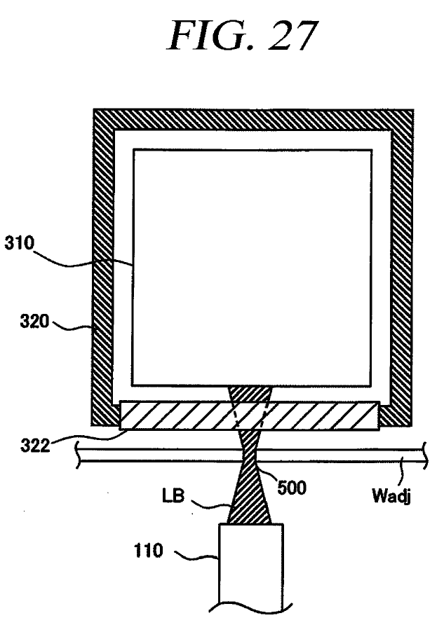

Furthermore, for example, it may be possible to place the ceramics block 310 in a vacuum container 320 and maintain the vicinity of the ceramics block 310 in a vacuum state, as illustrated in FIG. 27. In this configuration, since a thermal conduction between the ceramics block 310 and the external air can be suppressed, a higher measurement accuracy can be obtained. Further, the vacuum container 320 has a transmitting window 322 made of a material having a transmission band with respect to the wavelength of the laser beam LB. The laser beam LB emitted from the laser head 110 is transmitted through the transmitting window 322 and irradiated onto the ceramics block 310.

As stated above, in accordance with the present embodiment, it is possible to accurately adjust the focus, the spot diameter and the optical axis of the laser beam LB emitted from the laser head 110 in a short period of time, whereby the throughput of the process can be enhanced.

In the present embodiment, a process for removing the undesired material deposited on the end portion of the wafer W has been explained as an example of the process using the laser emitting device. However, the present invention is not limited thereto but can be applied to various processes using the laser emitting device.

Further, in the above-described embodiment, though the adjustment of the optical axis is carried out after the adjustment of the focus or the spot diameter of the laser beam LB has been completed, it is possible to carry out the adjustment of the focus or the spot diameter of the laser beam LB after performing the adjustment of the optical axis.

While the invention has been described with respect to the desirable embodiments with reference to the accompanying drawings, it is apparent that the present invention is not limited thereto. It would be understood by those skilled in the art that various changes and modifications may be made within the scope of the present invention described in claims, and it shall be understood that all modifications and embodiments conceived from the meaning and the scope of the claims and their equivalents are included in the scope of the present invention.

### INDUSTRIAL APPLICABILITY

The present invention can be applied to a method for adjusting a position of a laser emitting device which irradiates a laser beam onto a target substrate mounted on a mounting table.

What is claimed is:

1. A method for adjusting a position of a laser emitting device which irradiates a laser beam onto a rear surface of a target substrate mounted on a mounting table, wherein the laser emitting device is configured to be movable in an optical axis direction of the laser beam emitted therefrom, the method comprising:
setting, on the mounting table, an adjustment substrate, which is provided with a slit of a preset width extended toward a center from a peripheral portion of the adjustment substrate, so as to allow the laser beam emitted from the laser emitting device to pass through the slit;
irradiating the laser beam toward a light receiving surface of a light energy measuring device, which is disposed on a front surface side of the adjustment substrate, from a rear surface side of the adjustment substrate through the slit; and
measuring a variation in an energy amount of the laser beam irradiated onto the light receiving surface by the light energy measuring device while moving the laser emitting device in the optical axis direction, and adjusting the position of the laser emitting device in the optical axis direction to a desired position based on the variation in the energy amount on the light receiving surface.

2. The method of claim 1, wherein if the width of the slit is equal to or less than a diameter of a focus of the laser beam, the position of the laser emitting device in the optical axis direction is adjusted to a position at which the energy amount on the light receiving surface is maximum.

3. The method of claim 1, wherein if the width of the slit is larger than a diameter of a focus of the laser beam, the position of the laser emitting device in the optical axis direction is adjusted to a center position within a range in which the energy amount on the light receiving surface is in a saturated state.

4. The method of claim 1, wherein a spot diameter of the laser beam irradiated onto the rear surface of the target substrate is adjusted by adjusting the position of the laser emitting device in the optical axis direction such that a ratio with respect to a maximum value of the energy amount on the light receiving surface is reduced.

5. The method of claim 1, wherein, when having a desired spot diameter, a ratio with respect to a maximum value of the energy amount on the light receiving surface is calculated based on a ratio between a spot area of the laser beam at the rear surface of the adjustment substrate and the spot area's partial area exposed through the slit, and
the position of the laser emitting device in the optical axis direction is adjusted such that a ratio between the energy amount on the light receiving surface and the maximum value is equivalent to the calculated ratio.

6. A method for adjusting a position of a laser emitting device which irradiates a laser beam onto a rear surface of a target substrate mounted on a mounting table, wherein the laser emitting device is configured to be movable in an optical axis direction of the laser beam emitted therefrom, the method comprising:
mounting, on the mounting table, an adjustment substrate provided with a plurality of slits, which are formed in a radial shape and have different widths from each other;
selecting a slit having a width closest to a diameter of a focus of the laser beam among the plurality of slits, and adjusting a position of the adjustment substrate in order to allow the laser beam from the laser emitting device to pass through the selected slit;
irradiating the laser beam toward a light receiving surface of a light energy measuring device, which is disposed on a front surface side of the adjustment substrate, from a rear surface side of the adjustment substrate through the slit; and
measuring a variation in a energy amount of the laser beam irradiated onto the light receiving surface by the light energy measuring device while moving the laser emitting device in the optical axis direction of the laser beam, and adjusting the position of the laser emitting device in the optical axis direction to a desired position based on the variation in the energy amount on the light receiving surface.

7. A method for adjusting a position of a laser emitting device which irradiates a laser beam onto a rear surface of a target substrate mounted on a mounting table, wherein the laser emitting device is configured to be movable in a direction orthogonal to an optical axis direction of the laser beam emitted therefrom, the method comprising;
mounting, on the mounting table, an adjustment substrate having the same diameter as that of the target substrate;
irradiating the laser beam from a rear surface side of the adjustment substrate toward a light receiving surface of a light energy measuring device disposed on a front surface side of the adjustment substrate;
measuring a variation in an energy amount of the laser beam irradiated onto the light receiving surface by the light energy measuring device while moving the laser emitting device from an outer side of a peripheral portion of the adjustment substrate to an inner side thereof or vice versa in the direction orthogonal to the optical axis direction, and adjusting the position of the laser emitting device in the direction orthogonal to the optical axis direction based on the variation in the energy amount on the light receiving surface.

8. The method of claim 7, wherein, in the process of adjusting the position of the laser emitting device, the position of the laser emitting device in the direction orthogonal to the optical axis direction is adjusted to a desired position based on a position of the laser emitting device corresponding to a center between variation points among a variation in the energy amount on the light receiving surface obtained when the laser emitting device is moved between a portion at which a spot of the laser beam is completely not blocked by the adjustment substrate at the outer side of the peripheral portion of the adjustment substrate and a portion at which the spot of the laser emitting device is completely blocked by the adjustment substrate at the inner side of the peripheral portion of the adjustment substrate.

9. The method of claim 8, further comprising:
obtaining a spot diameter of the laser beam from a position difference of the laser emitting device between the variation points of the energy amount on the light receiving surface.

10. A method for adjusting a position of a laser emitting device which irradiates a laser beam onto a rear surface of a target substrate mounted on a mounting table, wherein the laser emitting device is configured to be movable in an optical axis direction of the laser beam emitted therefrom and also in a direction orthogonal to the optical axis direction, the method comprising:
a position adjusting process, in the optical axis direction, of mounting, on the mounting table, an adjustment substrate having the same diameter as that of the target substrate and including a slit with a preset width extended from a peripheral portion toward a center; adjusting the adjustment substrate in order for the laser beam emitted from the laser emitting device to pass through the slit; irradiating the laser beam to pass through the slit from a rear surface side of the adjustment substrate onto a light receiving surface of a light energy measuring device disposed on a front surface side of the adjustment substrate; measuring a variation in an energy amount of the laser beam irradiated onto the light receiving surface by the light energy measuring device while moving the laser emitting device in the optical axis direction; and adjusting a position of the laser emitting device in the optical axis direction to a desired position based on the variation in the energy amount on the light receiving surface; and
a position adjusting process, in the direction orthogonal to the optical axis direction, of adjusting the position of the adjustment substrate on the mounting table to a position at which the laser beam does not pass through the slit; irradiating the laser beam from the rear surface side of the adjustment substrate onto the light receiving surface of the light energy measuring device disposed on the front surface side of the adjustment substrate; measuring a variation in an energy amount of the laser beam irradiated onto the light receiving surface by the light energy measuring device while moving the laser emitting device from an inner side toward an outer side of the peripheral portion of the adjustment substrate in the direction orthogonal to the optical axis direction; and adjusting the position of the laser emitting device in the direction orthogonal to the optical axis direction to a desired position based on the variation in the energy amount on the light receiving surface.

11. The method of claim 1, wherein the light energy measuring device includes:
a heating element for generating heat depending on the energy amount on the light receiving surface;
a temperature measuring device for measuring a temperature of the heating element; and
a vacuum container for maintaining the vicinity of the heating element in a vacuum atmosphere.

12. The method of claim 1, wherein the light energy measuring device includes:
a heating element made of ceramics which generates heat depending on the energy amount on the light receiving surface; and
a temperature measuring device for measuring a temperature of the heating element.
